(19) United States
(12) Patent Application Publication
(10) Pub. No.: US 2024/0132170 A1
(43) Pub. Date: Apr. 25, 2024

(54) WHEELS, WHEEL ASSEMBLIES AND TRACK SYSTEMS

(71) Applicant: SOUCY INTERNATIONAL INC., Drummondville (CA)

(72) Inventor: Anthony DEZIEL, Trois-Rivieres (CA)

(21) Appl. No.: 18/488,414

(22) Filed: Oct. 16, 2023

Related U.S. Application Data
(60) Provisional application No. 63/417,899, filed on Oct. 20, 2022.

(51) Int. Cl. B62D 55/14; B62D 55/10; B62D 55/12

(52) U.S. Cl. CPC B62D 55/14; B62D 55/10; B62D 55/12

(57) ABSTRACT

A wheel for a track assembly is disclosed. The wheel includes an integrally formed body having hub and rim portions and first and second walls. The first and second walls, which connect the rim and hub portions, extend radially therebetween. The hub and rim portions and the first and second walls define an interior chamber configured to hold forming material. The first wall defines an aperture providing a pathway to the interior chamber for the evacuation of the forming material, and the aperture being shaped for evacuating debris introduced into the interior chamber in operation. A track system having the same is also disclosed.

### CROSS-REFERENCE TO RELATED APPLICATION

The present application claims priority to U.S. Provisional Patent Application No. 63/417,899, filed Oct. 20, 2022 entitled “Wheels, Wheel Assemblies And Track Systems”, which is incorporated by reference herein in its entirety.

### TECHNICAL FIELD

The present application generally relates to wheels, wheel assemblies and track systems.

### BACKGROUND

Certain vehicles, such as, for example, agricultural vehicles (e.g., harvesters, combines, tractors, etc.), construction vehicles (e.g., trucks, front-end loaders, etc.), military vehicles (MTVs, tanks, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. Track systems for heavy vehicles use wheels that can be heavy. Heavy wheels can have a negative impact on a life of an endless track of the track system and on an efficiency of the track system, as it requires more energy to operate the track system.

Therefore, there is a desire for a wheel and/or a track system that could mitigate the above-mentioned issues.

### SUMMARY

It is an object of the present technology to ameliorate at least some of the inconveniences present in the prior art.

According to one aspect of the present technology, there is provided a wheel for a track assembly. The wheel includes an integrally formed body which has a hub portion, a rim portion and first and second walls. The first and second walls connect the rim and hub portions, and extend radially between the hub and rim portions. The hub portion, the rim portion, the first wall and the second wall define an interior chamber that is configured to hold forming material. The first wall defines an aperture that provides a pathway to the interior chamber for the evacuation of the forming material. The aperture is shaped for evacuating debris introduced into the interior chamber during operation.

In some embodiments, the aperture extends radially along of the first wall.

In some embodiments, the aperture extends radially and circumferentially along the first wall.

In some embodiments, the aperture is tapered in a radial direction of the first wall.

In some embodiments, the aperture radially extends into the rim portion.

In some embodiments, the first wall has an arcuate section, and the aperture is at least partially defined in the arcuate section.

In some embodiments, the rim portion has an inner surface and an outer surface, the inner surface being laterally sloped from a longitudinal center plane of the wheel towards the first wall.

In some embodiments, the aperture has a radially inner section and a radially outer section, the radially inner section having a first width and the radially outer section having a second width, the first width being different from the second width.

In some embodiments, the first width is larger than the second width.

In some embodiments, the second width is larger than the first width.

In some embodiments, wherein the first width is about 36 mm.

In some embodiments, wherein the second width is about 27 mm.

In some embodiments, the aperture is a first aperture, and the second wall defines a second aperture providing a pathway to the interior chamber for the evacuation of the forming material, and shaped for evacuating debris introduced into the interior chamber in operation.

In some embodiments, the first aperture has a radially elongated shape and the second aperture has a circular shape.

In some embodiments, the second aperture has a diameter of about 57 mm.

In some embodiments, the first aperture is tapered along a radial direction of the first wall, and the second aperture has a circular shape.

In some embodiments, the first wall defines a plurality of apertures, including the aperture and an other aperture. The other aperture provides a pathway to the interior chamber for the evacuation of the forming material, and is shaped for evacuating debris introduced into the interior chamber during movement of the wheel.

In some embodiments, the plurality of apertures is circumferentially spaced from one another.

In some embodiments, the aperture has a radially elongated shape and the other aperture has a circular shape.

In some embodiments, the hub portion has an outer radial surface, the rim portion has an inner radial surface, the first wall has a first inner lateral surface, the second wall has a second inner lateral surface, and the interior chamber is defined by the outer radial surface of the hub portion, the inner radial surface of the rim portion, the first inner lateral surface of the first wall and the second inner lateral surface of the second wall.

In some embodiments, the integrally formed body is a cast body, and the forming material is a casting material.

In some embodiments, the casting material is sand.

According to another aspect of the present technology, there is provided a tandem wheel assembly including a connecting structure, a first wheel according to the above aspect or according to the above aspect and one or more of the above embodiments, a first axle, a second wheel according to the above aspect or according to the above aspect and one or more of the above embodiments and a second axle. The hub portion of the first wheel defines a first hub aperture, and the hub portion of the second wheel defines a second hub aperture. The first axle is receivable in the first hub aperture, and the first axle is connectable to the connecting structure. The second axle is receivable in the second hub aperture, and the second axle is connectable to the connecting structure.

In some embodiments of the tandem wheel assembly, the second axle is longitudinally spaced from the first axle.

In some embodiments of the tandem wheel assembly, the second axle is laterally spaced from the first axle.

In some embodiments of the tandem wheel assembly, the second axle is longitudinally spaced and laterally spaced from the first axle.

According to another aspect of the present technology, there is provided a track system comprising, a frame, a sprocket wheel assembly rotationally connected to the frame, an idler wheel assembly rotationally connected to the frame, a plurality of support wheel assemblies rotationally connected to the frame. At least one of the idler wheel assembly and the plurality of support wheel assemblies includes a wheel. The wheel includes an integrally formed body having a hub portion, a rim portion and first and second walls. The first and second walls, which connect the rim and hub portions, extend radially between the hub and rim portions. The hub portion, the rim portion, the first wall and the second wall define an interior chamber configured to hold forming material. The first wall defines an aperture providing a pathway to the interior chamber for the evacuation of the forming material. The aperture is shaped for evacuating debris introduced into the interior chamber in operation.

In some embodiments, the aperture extends radially along of the first wall.

In some embodiments, the aperture extends radially and circumferentially along the first wall.

In some embodiments, the aperture is tapered in a radial direction of the first wall.

In some embodiments, the aperture radially extends into the rim portion.

In some embodiments, the first wall has an arcuate section, and the aperture is at least partially defined in the arcuate section.

In some embodiments, the rim portion has an inner surface and an outer surface, the inner surface being laterally sloped from a longitudinal center plane of the wheel towards the first wall.

In some embodiments, the aperture has a radially inner section and a radially outer section, the radially inner section having a first width and the radially outer section having a second width, the first width being different from the second width.

In some embodiments, the first width is larger than the second width.

In some embodiments, the second width is larger than the first width.

In some embodiments, the first width is about 36 mm.

In some embodiments, the second width is about 27 mm.

In some embodiments, the aperture is a first aperture, and the second wall defines a second aperture providing a pathway to the interior chamber for the evacuation of the forming material, and shaped for evacuating debris introduced into the interior chamber in operation.

In some embodiments, the first aperture has a radially elongated shape and the second aperture has a circular shape.

In some embodiments, the second aperture has a diameter of about 57 mm.

In some embodiments, the first aperture is tapered along a radial direction of the first wall, and the second aperture has a circular shape.

In some embodiments, the first wall defines a plurality of apertures, including the aperture and an other aperture, the other aperture provides a pathway to the interior chamber for the evacuation of the forming material, and shaped for evacuating debris introduced into the interior chamber during movement of the wheel.

In some embodiments, the plurality of apertures is circumferentially spaced from one another.

In some embodiments, the aperture has a radially elongated shape and the other aperture has a circular shape.

In some embodiments, the hub portion has an outer radial surface, the rim portion has an inner radial surface, the first wall has a first inner lateral surface, the second wall has a second inner lateral surface, and the interior chamber is defined by the outer radial surface of the hub portion, the inner radial surface of the rim portion, the first inner lateral surface of the first wall and the second inner lateral surface of the second wall.

In some embodiments, the integrally formed body is a cast body, and the forming material is a casting material.

In some embodiments, the casting material is sand.

In some embodiments, one of the plurality of support wheel assemblies includes the wheel, and is a tandem wheel assembly.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by an operator of the track system when the track system is in an upright position, at rest on a flat, level surface.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternate features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from top, front and right side of track system including a wheel according to an embodiment of the present technology;

FIG. 2 is a right side elevation view of the track system of FIG. 1;

FIG. 3 is a perspective view taken from a top, rear and right side of the wheel of FIG. 1;

FIG. 4 is a right side elevation view of the wheel of FIG. 3;

FIG. 5 is a left side elevation view of the wheel of FIG. 3;

FIG. 6 is a cross-sectional view of the wheel of FIG. 3 taken along the line 6-6 of FIG. 4;

FIG. 7 is a cross-sectional perspective view taken from a bottom, rear and right side of the wheel of FIG. 3 taken along the line 6-6 of FIG. 4;

FIG. 8 is a cross-sectional perspective view taken from a top, rear and left side of the wheel of FIG. 3 taken along the line 6-6 of FIG. 4;

FIG. 9A is a close-up right side elevation view of a portion of the wheel of FIG. 3;

FIG. 9B is a close-up right side elevation view of a portion of an other wheel in accordance with at least some embodiments of the present technology;

FIG. 10 is a close-up left side elevation view of a portion of the wheel of FIG. 3;

FIG. 11 is a close-up cross-sectional view of a portion of the wheel of FIG. 3 taken along the line 6-6 of FIG. 4;

FIG. 12 is a close-up cross-sectional view of a wheel according to an alternate embodiment of the present technology;

FIG. 13 is a close-up cross-sectional view of a wheel according to an alternate embodiment of the present technology;

FIG. 14 is a side elevation view of a wheel according to an alternate embodiment of the present technology; and

FIG. 15 is a cross-sectional view of a wheel as known in the prior art.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

### Track System

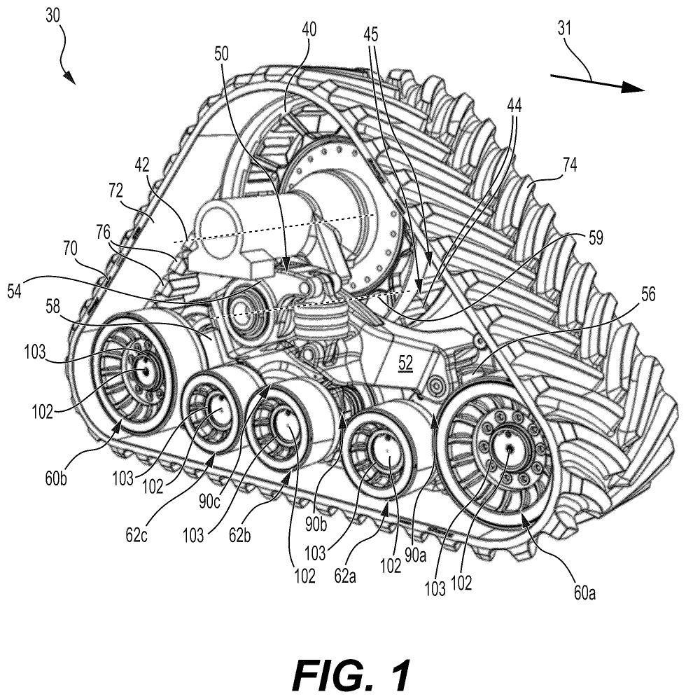

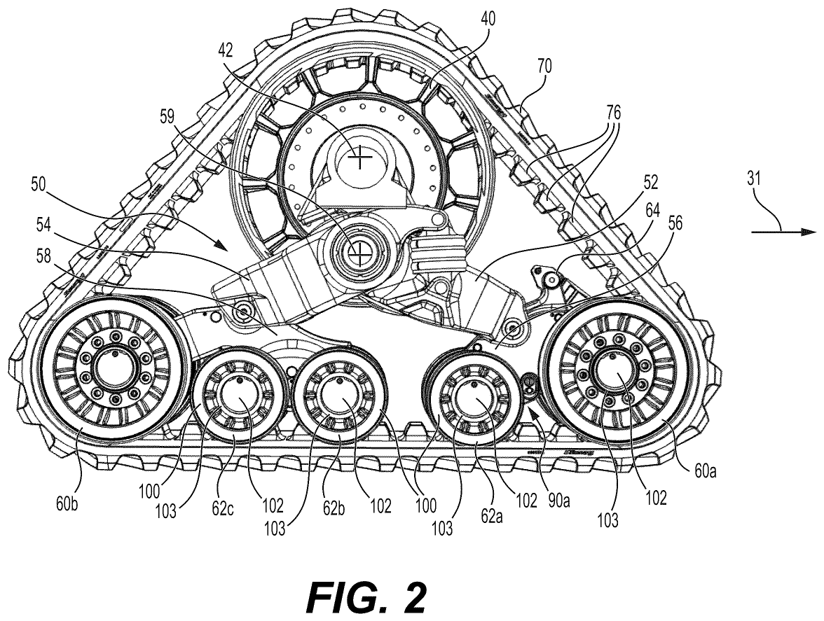

Referring to FIGS. 1 and 2, the present technology will be described with reference to a track system 30, the forward direction of which is indicated by arrow 31. The track system 30 is operatively connectable to a vehicle (not shown). Specifically, the track system 30 is operatively connectable to a shaft of the vehicle. In some embodiments, the vehicle is an agricultural vehicle such as a harvester, a combine or a tractor. In other embodiments, the vehicle is a construction vehicle such as a bulldozer, a skid-steer loader, an excavator or a compact track loader. In yet other embodiments, the vehicle is a recreational vehicle such as an all-terrain-vehicle, a side-by-side vehicle or utility-terrain vehicle. It is further contemplated that the present technology could be used with industrial and military vehicles as well. It is also contemplated that the present technology could be used with trailers or other unpowered vehicles.

The track system 30 includes a sprocket wheel assembly 40 which can be operatively connected to a driving axle (not shown) of the vehicle. It is contemplated that in some embodiments, the sprocket wheel assembly 40 could be connected to a non-driving axle. The driving axle is configured to drive the sprocket wheel assembly 40 such that the sprocket wheel assembly 40 can rotate about a sprocket axis 42. The sprocket axis 42 is generally perpendicular to the forward direction of travel of the track system 30. The sprocket wheel assembly 40 has a plurality of extending engaging members 44 (i.e., teeth) disposed on a circumference thereof. The sprocket wheel assembly 40 defines a plurality of recesses 45, where each one of the recesses 45 is defined between two engaging members 44. The engaging members 44 and the recesses 45 are adapted, as will be described in greater detail below, to engage with lugs 76 provided on an inner surface 72 of an endless track 70. It is contemplated that in other embodiments, the configuration of the sprocket wheel assembly 40 could differ without departing from the scope of the present technology.

The track system 30 further includes a frame 50. The frame 50 includes a leading frame member 52, a trailing frame member 54, a leading wheel connecting member 56, and a trailing wheel connecting member 58. The leading and trailing frame members 52, 54 are pivotally connected to one another, such that the leading and trailing frame members 52, 54 can pivot relative to one another about a pivot axis 59. The joint connection is positioned laterally outwardly from the sprocket wheel assembly 40. The leading frame member 52, which extends from the pivot axis 59 in the forward and downward directions, is also pivotally connected to the leading wheel connecting member 56 On the other hand, the trailing frame member 54, which extends from the pivot axis 59 in the rearward and downward directions, is also pivotally connected to the trailing wheel connecting member 58. Thus, in the present embodiment, the frame 50 is made of multiple distinct members connected to one another. It is contemplated that in other embodiments, one or more members could be integral. It is further contemplated that in some embodiments, the frame 50 could include more or less than three members. In some implementations of the present technology, members could not be pivotally connected to one another. For instance, the leading and trailing frame members 52, 54 could be rigidly (i.e., not pivotally) connected to one another.

With continued reference to FIGS. 1 and 2, the track system 30 includes a leading idler wheel assembly 60a, a trailing idler wheel assembly 60b, and three support wheel assemblies 62a, 62b, 62c. Each of the leading and trailing idler wheel assemblies 60a, 60b includes two laterally spaced wheels. Likewise, each of the support wheel assemblies 62a, 62b, 62c includes two laterally spaced wheels 100, according to an embodiment of the present technology. It is contemplated that in some embodiments, at least one of the leading and trailing idler wheel assemblies 60a, 60b, and the four support wheel assemblies 62a, 62b, 62c could have a single wheel, or three or more wheels.

The leading idler wheel assembly 60a is rotationally connected to a leading end of the leading wheel connecting member 56. The leading idler wheel assembly 56 is operatively connected to a tensioner 64. The tensioner 64 is operable to adjust the tension in the endless track 70 by selectively moving the leading idler wheel assembly 60a toward or away from the frame 50. In some embodiments, the tensioner 64 could be omitted.

The support wheel assembly 62a is rotationally connected to the leading wheel connecting member 56 by a support structure 90a rearward from the leading idler wheel assembly 60a. In some embodiments, the support structure 90a could enable the support wheel assembly 62a to pivot relative to the leading wheel connecting member 56 about a longitudinally extending axis.

The support wheel assemblies 62b, 62c are rotationally connected to a leading end of the trailing wheel connecting member 58 by, respectively, support structures 90b, 90c. In some embodiments, the support structures 90b, 90c could, respectively, enable the support wheel assemblies 62b, 62c to pivot relative to the trailing wheel connecting member 58 about a longitudinally extending axis.

The support wheel assemblies 62a, 62b, 62c will be described in greater detail below.

The trailing idler wheel assembly 60b is connected to the trailing wheel connecting member 58 rearward from the support wheel assemblies 62b, 62c. It is contemplated that in some embodiments, the tensioner 64 could be connected to the trailing idler wheel assembly 60b.

The track system 30 also includes the endless track 70, which extends around components of the track system 50, notably the frame 50, the leading and trailing idler wheel assemblies 60a, 60b, the support wheel assemblies 62a, 62b, 62c and the support structures 90a, 90b, 90c. The endless track 70 has the inner surface 72 and an outer surface 74. The inner surface 72 of endless track 70 has the lugs 76, which are adapted to engage within the engaging members 44 of the sprocket wheel assembly 40. In the present embodiment, there is a single set of longitudinally spaced lugs 76. It is contemplated that in some embodiments, there could be two or more set of lugs 76. For example, in some embodiments, there could be two laterally spaced sets of longitudinally spaced lugs. The outer surface 74 of the endless track 70 has a tread defined thereon. It is contemplated that the tread could vary from one embodiment to another. In some embodiments, the tread could depend on the type of vehicle on which the track system 30 is to be used and/or the type of ground surface on which the vehicle is destined to travel. In the present embodiment, the endless track 70 is an endless polymeric track. It is contemplated that in some embodiments, the endless track 70 could be constructed of a wide variety of materials and structures.

The support wheel assemblies 62a, 62b, 62c will now be described. The support wheel assemblies 62a, 62b, 62c are generally similar. It is contemplated that in other embodiments, a diameter of the wheels 100 of one or more of the support wheel assemblies 62a, 62b, 62c could differ from one support wheel assembly to another. Additionally, in some embodiments, the support wheel assemblies 62b, 62c could be a tandem wheel assembly. As the support wheel assemblies 62a, 62b, 62c are similar, only the support wheel assembly 62a will be described in detail herewith.

As mentioned above, the support wheel assembly 62a includes the two laterally spaced wheels 100, which are generally similar to one another. The support wheel assembly 62a also includes an axle 102 (shown in FIGS. 1 and 2) interconnecting the two wheels 100, and bearings 103 disposed between the wheels 100 and the axle 102. In some embodiments, the bearings 103 could be omitted. It is understood that the support wheel assembly 62a includes other components such as fasteners. It is contemplated that in some embodiments, the support wheel assembly 62a could include three or more wheels.

In some implementations of the present technology, the wheel assembly 62a could be configured to have the wheels 100 longitudinally spaced from one another. Thus, the wheel assembly 62a could be a tandem wheel assembly or a double tandem wheel assembly, such that axles of the wheels 100, which would also be longitudinally spaced from one another, would be connected to a longitudinally extending member that would, in turn, be connected to the leading wheel connecting member 56.

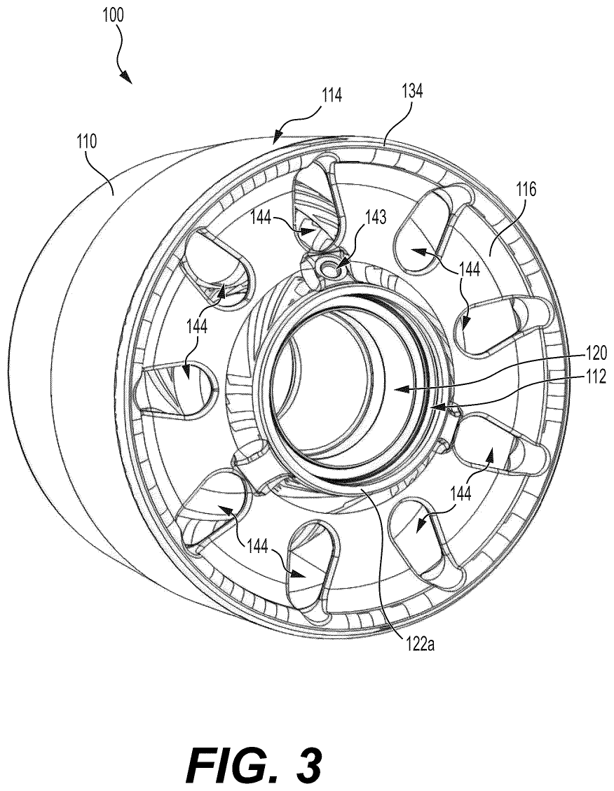

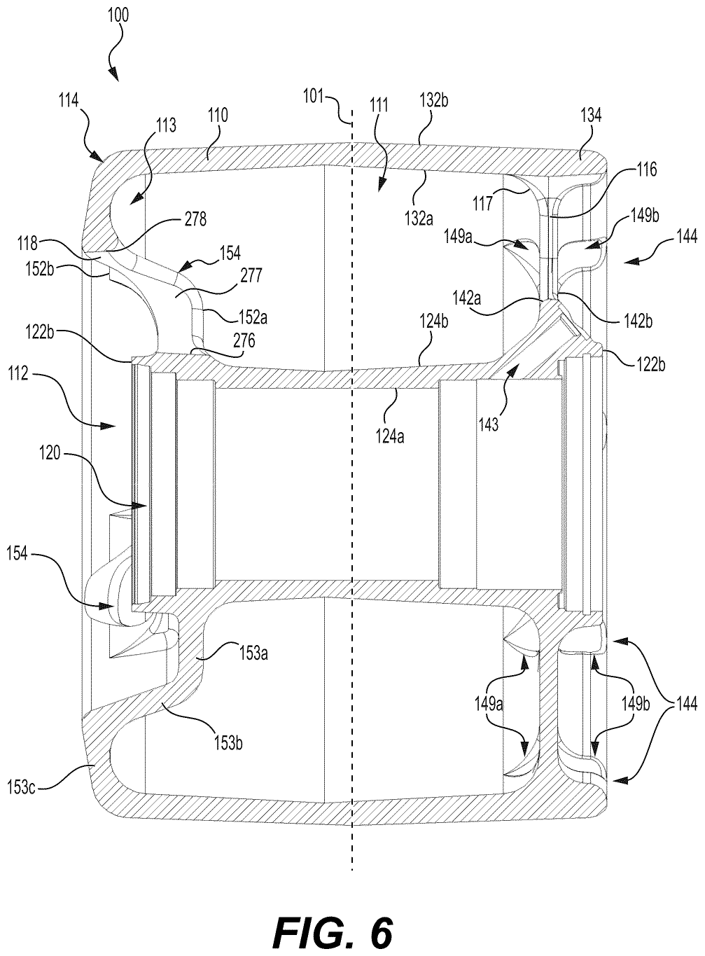

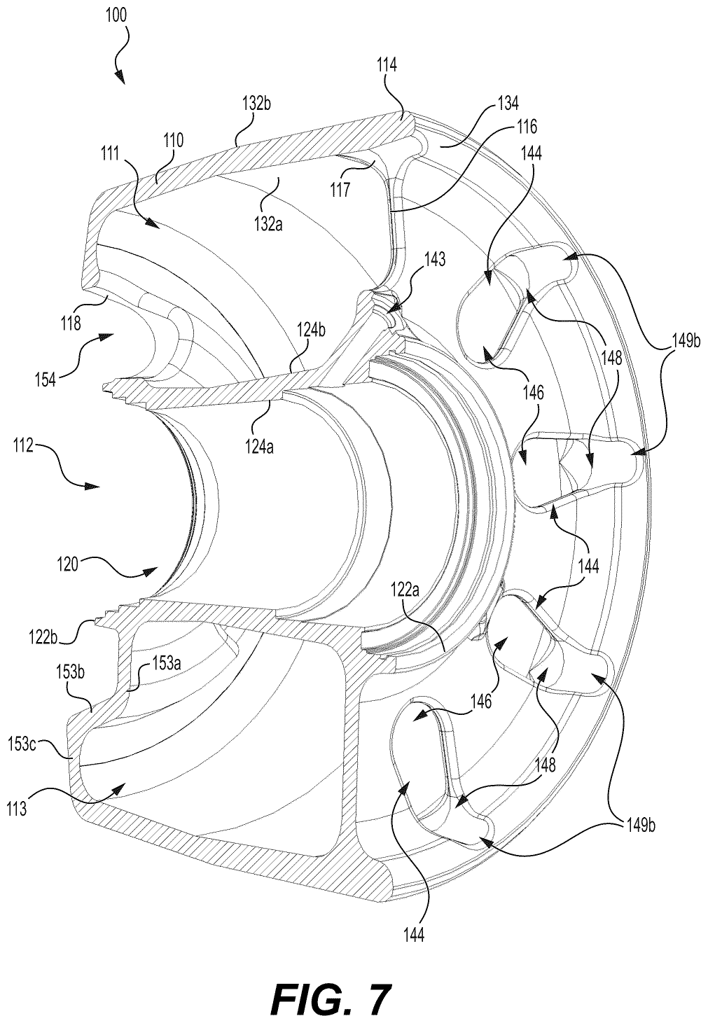

One of the wheels 100 is depicted in FIGS. 3 to 5. It should be noted that the other wheel 100 can be embodied as a mirror image of the wheel 100 depicted in FIG. 3, and hence will not be discussed in greater details herein below for sake of brevity. The wheel 100 has an integrally formed body 110. In other words, the wheel 100 is made of one integral piece. That said, it is contemplated that components could be connected to the body 110 (e.g., fasteners). Furthermore, the body 110 defines an interior chamber 111 (seen in FIGS. 6 to 8), such that the body 110 is hollow. This can result in the wheel 100 being lighter than other wheels used in track systems (e.g., non-hollow wheels). Having lighter wheels can assist in improving efficiency of the track system 30.

As will be described in greater detail below, the interior chamber 111 can be formed by a casting process. Broadly, casting is a manufacturing process in which a liquid (generally molten metal) is poured into a mold. Upon cooling, the liquid turns into a solid, where a shape thereof is given by the mold. Sometimes, when hollow objects, such as the wheel 100, are to be molded, a forming material that is configured to sustain operating conditions of the casting process (e.g., high temperatures) is used along with the mold to define apertures, cavities and/or recesses. The forming material can be, for example, sand. The forming material can then be removed from within the object through an aperture of the molded item. Such apertures are used to provide a path for evacuating the forming material from the interior chamber of the object. As it will become apparent from the description herein further below, developers of the present technology have devised wheels that are formed via a casting process and defines apertures for not only evacuating casting material, but also debris that is introduced within the interior chamber during operation.

Returning to the wheel 100, the body 110 includes a hub portion 112, a rim portion 114, a wall 116, and a wall 118, where the walls 116, 118 connect the hub portion 112 to the rim portion 114. Specifically, the wall 116 is a side wall 116 extending radially between the hub portion 112 and the rim portion 114 on one lateral side of the body 110, and the wall 118 is a side wall 118 extending radially between the hub portion 112 and the rim portion 114 on the other lateral side of the body 110.

The hub portion 112 defines a hub aperture 120 that is configured to receive the bearing 103 and the axle 102. In the illustrated embodiment, the hub aperture 120 is a circular aperture 120. It is contemplated that in other embodiments, the hub aperture 120 could have another shape. The hub portion 112 also has lips 122a, 122b. The lip 122a is disposed on one lateral side of the hub portion 112, and extends laterally, beyond the wall 116. Similarly, the lip 122b is disposed on the other lateral side of the hub portion 112, and extends laterally, beyond the wall 118. The hub portion 112 has an inner radial surface 124a, and an outer radial surface 124b. The outer radial surface 124b has a concave profile. It is contemplated that in other embodiments, the outer radial surface 124b could have a convex profile or a flat profile. As will be described below, the outer radial surface 124b partially defines the interior chamber 111.

The rim portion 114, which, as mentioned above, is connected to the hub portion 112 by the walls 116, 118, has an inner radial surface 132a, and an outer radial surface 132b.

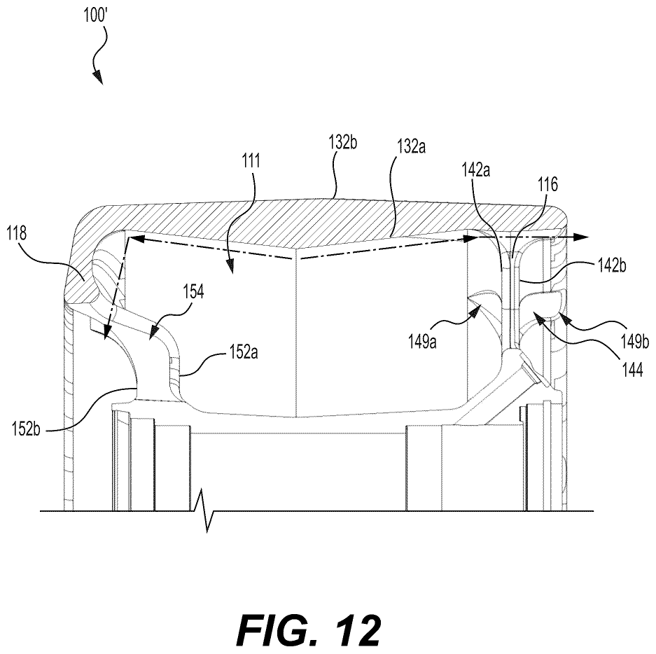

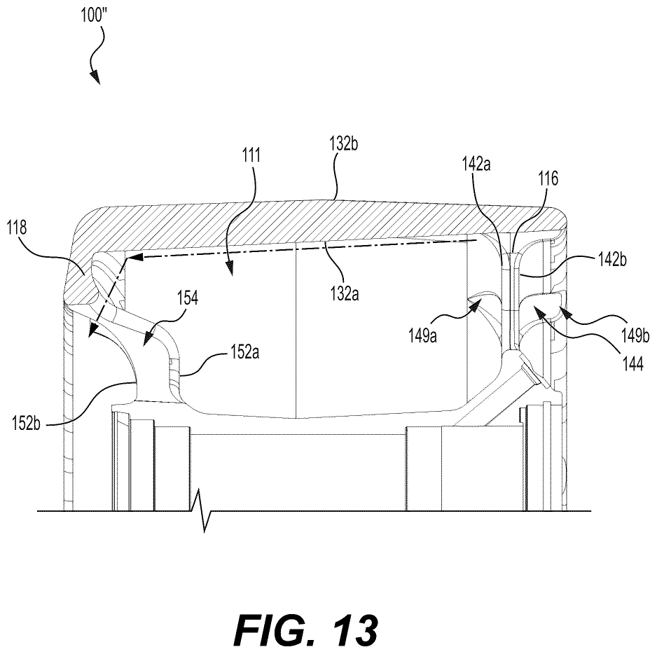

In one embodiment, the inner radial surface 132a has a concave profile, such that the inner radial surface 132a of the rim portion 114 is sloped from a longitudinal center plane 101 of the wheel 100 towards the wall 116. As will be described below, the slope of the inner radial surface 132a can assist in evacuating the debris from the inner chamber 111 via apertures 144, 154. With reference to FIG. 12, according to another embodiment of the wheel 100, namely 100′, the inner radial surface 132a has a convex profile. The convex profile can also assist in evacuating the debris from the inner chamber 111 via the apertures 144, 154. A potential path followed by the debris in the embodiment illustrated in FIG. 12 is shown in dash-dotted lines therein. With reference to FIG. 13, according to yet another embodiment of the wheel 100, namely 100″, the inner radial surface 132a has a tapered profile. The tapered profile can also assist in evacuating the debris from the inner chamber 111 via the apertures 154. A potential path followed by the debris in the embodiment illustrated in FIG. 13 is shown in dash-dotted lines therein. Although, in FIG. 13, the inner radial surface 132a is tapered such that a thickness of the rim portion 114 is greater proximate to the wall 118 than proximate to the wall 116, it is contemplated that in other embodiments, the inner radial surface 132a could be tapered such that the thickness of the rim portion 114 is greater proximate to the wall 116 than proximate to the wall 118. In such embodiments, the tapered profile could assist in evacuating the debris from the inner chamber 111 via the apertures 144. It is further contemplated that in other embodiments, the inner radial surface 132a could have a flat profile. Referring back to FIG. 6, the outer radial surface 132b has a convex profile. The convex profile of the outer radial surface 132b can assist in creating a pre-determined profile of pressure distribution on the inner surface 72 of the endless track 70. Additionally, the convex profile of the outer radial surface 132b can assist in increasing rigidity and/or strength of the wheel 100. It is contemplated that in other embodiments, the outer radial surface 132b could have a concave profile or a flat profile. As will be described in greater detail below, the inner radial surface 132a partially defines the interior chamber 111.

Furthermore, the rim portion 114 has, on one lateral side thereof, an overhang 134. The overhang 134 can, notably, increase a surface of the outer radial surface 132b, which can assist in reducing a pressure applied by the wheel 100 on the endless track 70.

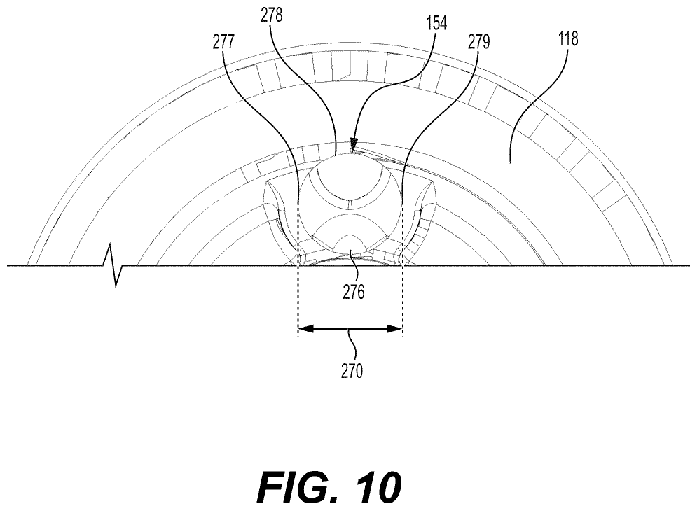

With reference to FIGS. 3 to 10, the walls 116, 118 will now be described in greater detail. As will become apparent from the below, the walls 116, 118 are different from one another, though it is contemplated that according to some embodiments of the present technology, the walls 116, 118 could be similar to one another.

The wall 116 will first be described. The wall 116 extends from the hub portion 112 to the rim portion 114. Specifically, the wall 116 extends radially from the lip 122a to the overhang 134. The wall 116 has inner lateral surface 142a, and an outer lateral surface 142b. As will be described below, the inner lateral surface 142a partially defines the interior chamber 111. Proximate to the lip 122a, the wall 116 defines a lubricating aperture 143 which is configured to provide a passage for lubricating the bearings 103 (commonly referred to as a grease fitting or grease zerk). It is contemplated that the grease fitting could be disposed elsewhere along the wheel 100. In some embodiments, the grease fitting may be omitted. It is to be noted that the wall 116 has a fillet 117 between the inner radial surface 132a of the rim portion 114, and the inner lateral surface 142a of the wall 116. It is contemplated that a size of the fillet 117 (i.e., radius of fillet) could vary from one embodiment to another. The fillet 117 provides a sloped section between inner radial surface 132a and the inner lateral surface 142a. In some instances, it can be said that the fillet 117 is an arcuate section between inner radial surface 132a and the inner lateral surface 142a. As it will be discussed in greater details further below, provision of arcuate section by the fillet 117 may aid in evacuation of debris introduced inside the wheel 100. It is contemplated that in some embodiments, the wall 116 may be tapered such that a thickness of the wall 116 proximate to the rim portion 114 (radially outer point) may be greater than the thickness of the wall 116 proximate to the hub portion 112 (radially inner point). It can also be said that in some embodiments, the thickness of the wall 116 may be continuously decreasing from the rim portion 114 towards the hub portion 112. Furthermore, the wall 116 could be sloped such that a radially outer point of the inner lateral surface 142a defined in the wall 116 is laterally offset from a radially inner point of the inner lateral surface 142a defined in the wall 116.

### First Aperture

With reference to FIGS. 6 to 9A, the wall 116 defines a plurality of apertures 144 that are circumferentially spaced along the wall 116. Specifically, the wall 116 defines nine apertures 144. It is contemplated that in other embodiments, the wall 116 could define more or fewer apertures 144. As the apertures 144 are similar, only one aperture 144 will be described in detail herewith.

In this example, the aperture 144 extends radially along the wall 116. The aperture 144 has a radially inner section 146 and a radially outer section 148. The radially inner section 146 of the aperture 144 has an inner curved aperture wall segment 246, and the radially outer section 148 of the aperture 144 has an outer curved aperture wall segment 248. The inner curved aperture wall segment 246 and the outer curved aperture wall segment 248 are connected by a pair of intermediate aperture wall segments 247 and 249. The inner curved aperture wall segment 246, the outer curved aperture wall segment 248, and the intermediate aperture wall segments 247, 249 form an aperture wall that defines a perimeter of the aperture 144.

The aperture 144 has a length 220. In this example, the length 220 is about 65 mm. It is contemplated that in some embodiments, the length 220 could be about 60 mm. In other embodiments, the length 220 could be about 70 mm. The inner curved aperture wall segment 246 is equidistant from a virtual point 256 located in the radially inner section 146 of the aperture 144. The outer curved segment 248 is equidistant from a virtual point 258 located in the radially outer section 148 of the aperture 144. The virtual point 256 and the virtual point 258 are radially spaced along the aperture 144 by a distance 240. In this example, the distance 240 between the virtual point 256 and the virtual point 258 is about 34 mm. It is contemplated that in some embodiments, the distance 240 could be about 30 mm. In other embodiments, the distance 240 could be about 40 mm.

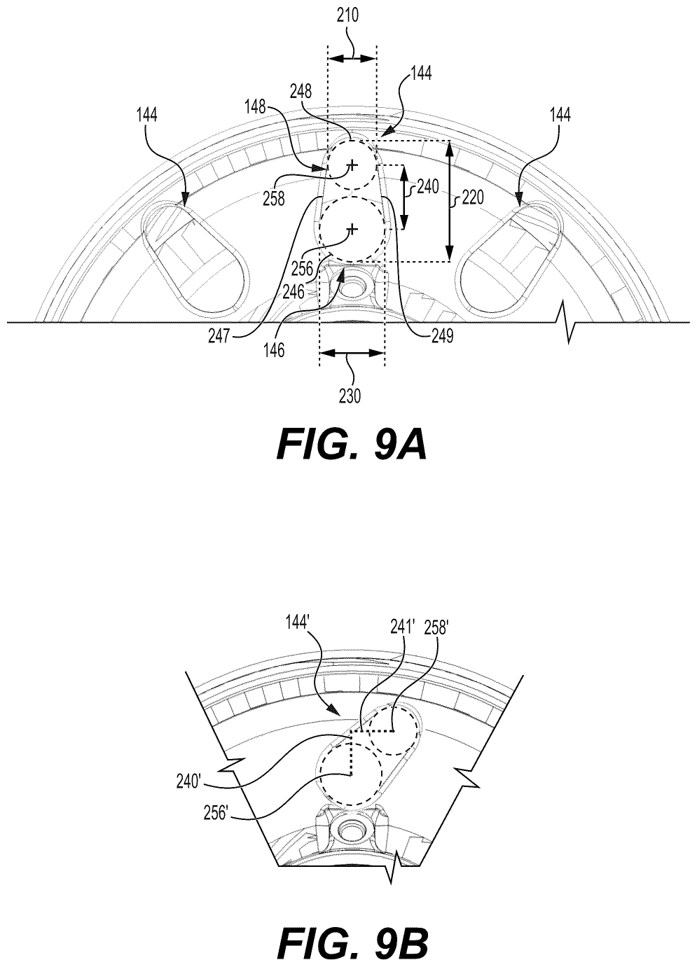

In some embodiments, the virtual points 256, 258 may be circumferentially spaced along the aperture 144 by a given distance. In other embodiments, the virtual points 256, 258 may be radially and circumferentially spaced along the aperture 144 by given distances. For example, with a quick reference to FIG. 9B, there is depicted an aperture 144′ of an other wheel in accordance with the present technology. In this example, an inner curved aperture wall segment of the aperture 144′ is equidistant from a virtual point 256′. In this example, an outer curved segment is equidistant from a virtual point 258′. The virtual point 256′ and the virtual point 258′ are both radially spaced along the aperture 144′ by a distance 240′ and circumferentially spaced along the aperture 144′ by a distance 241′.

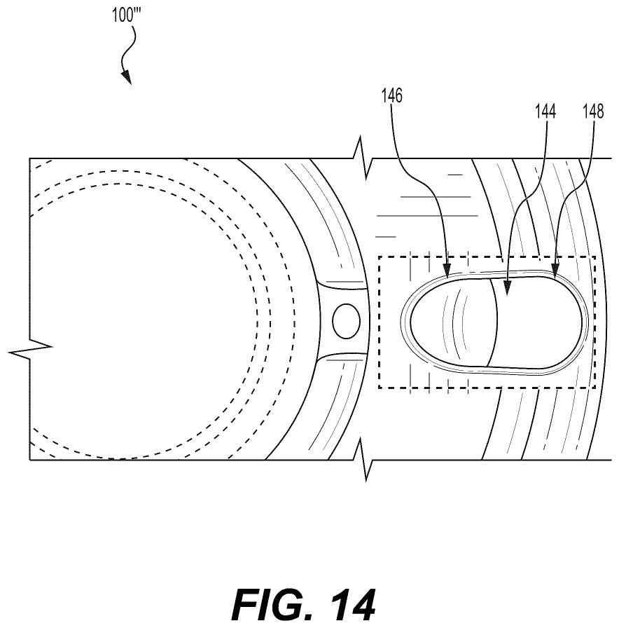

The radially inner section 146 has a width 230, and the radially outer section 148 has a width 210. In this example, the width 230 is about 36 mm. It is contemplated that in some embodiments, the width 230 could be about 30 mm. In other embodiments, the width 230 could be about 40 mm. On the other hand, the width 210 is about 27 mm. It is contemplated that in some embodiments, the width 210 could be about 20 mm. In other embodiments, the width 210 could be about 30 mm. In this embodiment, the radially inner section 146 is larger than the radially outer section 148 (e.g., the width 230 is larger than the width 210). However, in other embodiments, the radially outer section 148 may be larger than the radially inner section 146. For example, with reference to FIG. 14, which depicts an alternate embodiment of the wheel 100, namely wheel 100″, the radially outer section 148 is larger than the radially inner section 146, which can aid in evacuation of debris from the internal chamber 111, as will be described in greater detail below.

The intermediate segments 247 and 249 extend from the radially inner segment 146 towards the radially outer segment 148, which has a comparatively smaller width, thereby providing a tapered shape to the aperture 144. In this embodiment, the aperture 144 is radially tapered such that a width of the aperture 144 is reduced from the radially inner section 146 to the radially outer section 148. In the embodiment shown in FIGS. 6 to 9, the aperture 144 having a tapered shape can assist in minimizing the introduction of debris into the internal chamber 111, as the outer curved aperture wall segment 248, which is closer to the ground when the wheel 100 is rolling, is smaller than the inner curved aperture wall segment 246, thereby reducing chances of bigger sized debris from entering the internal chamber 111. In other embodiments, as shown in FIG. 14, the aperture 144 may be radially tapered such that the width of the aperture 144 is increased from the radially inner section 146 to the radially outer section 148. In this embodiment, the aperture 144 having a tapered shape can further assist in evacuating debris out of the internal chamber 111, since the outer curved aperture wall segment 248, which is closer to the ground when the wheel 100 is rolling, is bigger than the inner curved aperture wall segment 246 and therefore likely to facilitate debris exit. In some other embodiments, the aperture 144 could be linear (e.g., not tapered). In other words, the width 210 and the width 230 may be equal.

In further embodiments of the present technology, it can be said that an area of the radially inner section 146 is larger than an area of the radially outer section 148. It is contemplated that in other embodiments, the area of the radial inner section 146 can be smaller than the area of the radially outer section 148.

The radially inner section 146 is radially spaced from the lip 122a. In other embodiments, however, the radially inner section 146 could extend radially into the lip 122a. The radially outer section 148 extends radially into the overhang 134. In other words, the radially outer section 134 extends radially into the rim portion 114. It is contemplated that in some embodiments, the radially outer section 148 could be radially spaced from the overhang 134.

As mentioned above, the aperture 144 radially extends along the wall 116. However, it is contemplated that one or more apertures defined in the wall 116 may extend along other directions and/or orientations. In the example of FIG. 9A, the virtual point 256 and the virtual point 258 are circumferentially aligned. However, in other embodiments, the virtual point 256 and the virtual point 258 may not be circumferentially aligned, such that the corresponding aperture extends radially and circumferentially along the wall 116 without departing from the scope of the present technology. Thus, it is understood that a shape of the aperture 144 could vary without departing from the scope of the present technology. In some embodiments, the aperture 144 could be arcuate, could have an “S” shape or a “U” shape, could be a circle, etc.

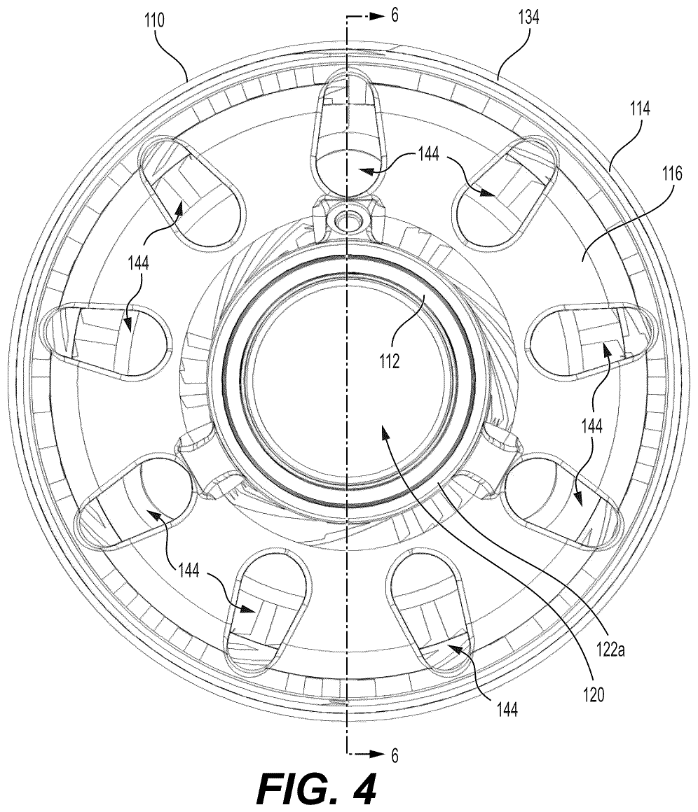

With reference to FIGS. 4, 5 and 6, the aperture 144 also partially extends laterally, through the wall 116. Specifically, the radially outer section 148 of the aperture 144 extends laterally and includes a laterally inner section 149a extending from the wall 116 towards the inner chamber 111, and a laterally outer section 149b extending from the wall 116 towards the overhang 134. The laterally inner section 149a has an arcuate profile. The laterally outer section 149b has an arcuate profile.

The slope of the inner radial surface 132a, in combination with the arcuate profile of the laterally inner section 149a can assist in evacuating debris from the inner chamber 111 via the aperture 144.

It is contemplated that in some embodiments, the apertures 144 could have different shapes. In one non-limiting example, half of the apertures 144 could have the radially inner section 146 be larger than the radially outer section 148, and the other half of the apertures 144 could have the radially outer section 148 be larger than the radially inner section 146. In an other non-limiting example, at least some of the apertures 144 may extend radially along the wall 116, while at least some others of the apertures 144 may extend both radially and circumferentially along the wall 116. These apertures 144 could be disposed in various sequences, such as alternatively to one another. Other configurations are also contemplated.

### Second Aperture

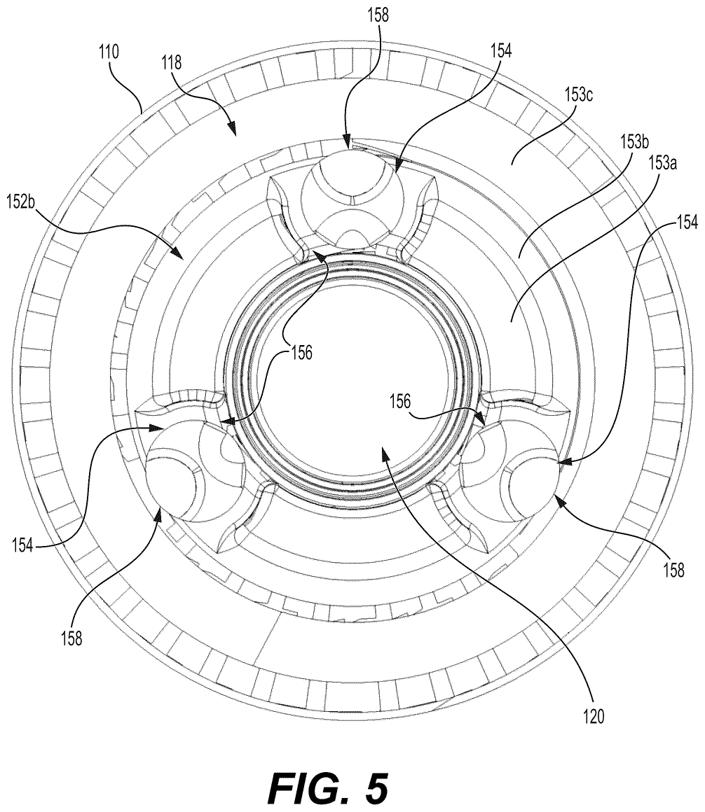

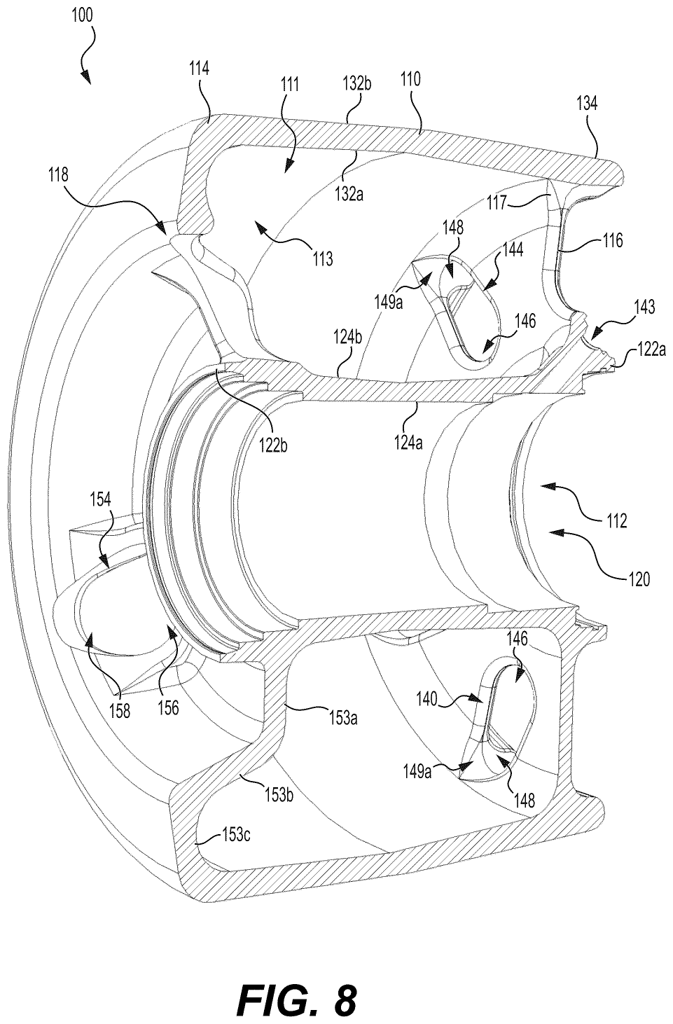

Turning now to the wall 118, the wall 118 has an inner lateral surface 152a, and an outer lateral surface 152b. As will be described below, the inner lateral surface 152a partially defines the interior chamber 111. Additionally, the wall 118 has a radially inner portion 153a, a radially intermediate portion 153b and a radially outer portion 153c. The radially inner portion 153a extends radially from the hub portion 112. The radially intermediate portion 153b extends radially and laterally from the radially inner portion 153a (best seen in FIGS. 6 and 8), and the radially outer portion 153c extends from the radially intermediate portion 153b to the rim portion 114. In some embodiments, the radially intermediate portion 153b could extend radially only (like the wall 116). In other embodiments, the radially intermediate portion 143b could extend laterally only (e.g., forming a perpendicular angle with the radially inner portion 153a). In instances where the radially intermediate portion 153b extends at least partially laterally, the interior chamber 111 has a side section 113. The wall 118 defines a plurality of apertures 154 that are circumferentially spaced. Specifically, the wall 118 defines three apertures 154. It is contemplated that in other embodiments, the wall 118 could define more or fewer apertures 154. As best seen in FIG. 5, each one of the apertures 154 is circumferentially aligned with one of the apertures 144, however this may not be the case in each and every embodiment of the present technology. As the apertures 154 are similar, only one aperture 154 will be described in detail herewith.

The aperture 154 extends from the lip 122b to the radially outer portion 153c. When seen from a side elevation view such as in FIG. 5, the aperture 154 has a circular shape with a diameter 270. In this example, the diameter 270 is about 57 mm. It is contemplated that in some embodiments, the diameter 270 could be about 50 mm. In other embodiments, the diameter 270 could be about 60 mm. It is contemplated that in some embodiments, the aperture 154 can have another shape. For example, in some instances, the aperture 154 may have a rectangular shape. In other embodiments, the aperture 154 could extend in the radial direction and circumferential direction, without departing from the scope of the present technology. In some embodiments, a shape and/or size of the aperture 154 could be substantially similar to the aperture 144. In some embodiments, the aperture 154 could be a scaled-down or a scaled-up version of the aperture 144, (i.e. having a similar shape but being smaller or larger than the aperture 144).

The aperture 154 has a radially inner section 156 and a radially outer section 158. Since a portion of the wall 118 extends in the lateral direction, the radially inner section 156 is laterally offset from the radially outer section 158. The radially inner section 156, which extends into the lip 122b, has an inner curved aperture wall segment 276. The radially outer section 158 extends into the radially intermediate portion 153b until the intersection between the radially intermediate portion 153b and the radially outer portion 153c. It is contemplated that in some embodiments, the radially outer section 148 could extend into the radially outer section 153c. The radially outer section 158 has an outer curved aperture wall segment 278. The inner curved aperture wall segment 276 and the outer curved aperture wall segment 278 are connected by a pair of intermediate aperture wall segments 277 and 279. The inner curved aperture wall segment 276, the outer curved aperture wall segment 278, and the intermediate aperture wall segments 277, and 279 form an aperture wall that defines a perimeter of the aperture 154. It is to be noted that due to the wall 118 extending in the lateral direction, the perimeter of the aperture 154 is generally that of an ellipse.

Thus, the aperture 154 extends in the lateral direction. In other words, the aperture 154 is sloped, as best seen in FIG. 8, such that the radially outer section 158 is both radially and laterally spaced from the radially inner section 156.

Turning to the wheel as a whole, the interior chamber 111 is defined by the radially outer surface 124b of the hub portion 112, by the radially inner surface of the inner surface 132a of the rim portion 114, by the laterally inner surface 142a of the wall 116, and by the laterally inner surface 152a of the wall 118. As mentioned above, the interior chamber 111 has the side section 113. The side section 113 may increase the rigidity to the wheel 100. It is contemplated that in some implementations of the present technology, some embodiments, the side section 113 could be omitted.

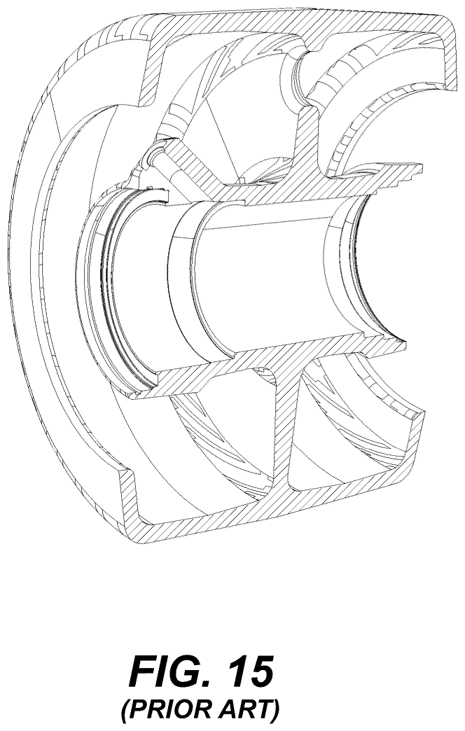

It should be noted that a given wheel as envisioned in at least some embodiments of the present technology may be more rigid when compared with conventional wheels for track systems. This is in notably due to the wheel 100 having the two (e.g., more than one) side walls 116, 118, as opposed to conventional wheels for track systems. Indeed, with reference to FIG. 15, which depicts a conventional wheel for a track system, there is a single radially extending member. In some embodiments, configuration of the wheel 100 may facilitate the manufacturing process thereof. In other embodiments, the configuration of the wheel 100 may aid in evacuation of debris while also providing additional reinforcement to the wheel 100. It is to be noted that the wheel 100 may also be more esthetically pleasing in comparison to some conventional wheels, without departing from the scope of the present technology.

### Operation

According to a non-limiting embodiment of the present technology, the wheel 100 is a cast wheel. In other words, wheel 100 is made from a casting process, which was briefly described hereabove. To cast the wheel 100, a molding material is used along with a mold to produce the interior chamber 111. The molding material can be sand.

Once the wheel 100 has been molded, the molding material is evacuated from the interior chamber 111 by the apertures 144, 154. In other words, the apertures 144, 154 provide a pathway from the interior chamber 111 to an exterior of the wheel 100 so that the molding material may be removed from the interior chamber 111. The wheel 100 can be manually handled (e.g., rotated about various planes) to remove the molding material from the interior chamber 111.

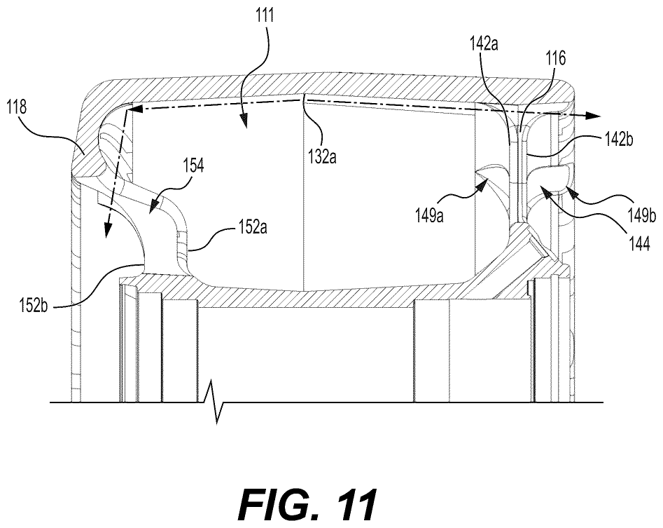

As will now be described with reference to FIG. 11, the apertures 144, 154, in addition to providing a pathway to remove molding material from the interior chamber 111, are also configured to evacuate debris that may be inserted within the interior chamber 111. In operation, when the track system 30 is in movement, the wheel 100 is also in movement (i.e., the wheel 100 rolls) such that some debris such as mud, snow and/or water may make their way into the interior chamber 111. However, the wheel 100 is configured to have the debris present within the interior chamber 111 evacuated therefrom through the apertures 144, 154.

Trajectories, shown in dash-dotted lines in FIG. 11, of debris being evacuated from the interior chamber 111 will now be provided. It is understood that that in some instances, debris could only follow part of the trajectory described hereinbelow.

Debris within the interior chamber 111 abut the inner radial surface 132a. In some instances, this may be due to the wheel 100 rolling. Then, the inner radial surface 132a directs debris towards one of the walls 116, 118 and away from the longitudinal center plane 101 due to the sloped profile of the inner radial surface 132a.

Debris are then guided outside of the interior chamber 111 through the apertures 144, 154. Specifically, when debris are directed towards the wall 116, debris are guided from the inner radial surface 132a toward the laterally inner section 149a of the aperture 144. The laterally inner section 149a extending into the rim portion 114 further guides debris into the aperture 144. Debris entering the laterally inner section 149a are then guided by the laterally outer section 149b towards the outside of the interior chamber 111.

In at least some implementations of the present technology, it should be noted that at least some debris guided towards the wall 116, which (for some reason) does not follow the laterally inner section 149a, can be guided by the laterally inner surface 142 towards the radially inner section 146, through which this other debris is evacuated from the interior chamber 111. In other words, the apertures 144 extending radially along the wheel 100 may increase the likelihood of debris being evacuated from the interior chamber 111.

When debris are directed towards the wall 118, debris are guided from the inner radial surface 132a toward the side section 113. From there, debris can be evacuated through the aperture 154. Evacuation of debris located in the side section 113 may further be facilitated due to the aperture 154 extending partially in the lateral direction.

It is to be noted that although the present technology is described with reference to the support wheel assembly 62a, a wheel according to the present technology could be used differently, such as with the idler wheel assembly 62a for instance.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A wheel for a track assembly, the wheel comprising:
an integrally formed body including:
a hub portion;
a rim portion; and
a first wall and a second wall, the first and second walls connecting the rim and hub portions, and extending radially between the hub and rim portions;
the hub portion, the rim portion, the first wall and the second wall defining an interior chamber configured to hold forming material; and
the first wall defining an aperture providing a pathway to the interior chamber for the evacuation of the forming material, and the aperture being shaped for evacuating debris introduced into the interior chamber in operation.

2. The wheel of claim 1, wherein the aperture extends in at least one of a radial and circumferential direction along of the first wall.

3. The wheel of claim 2, wherein the aperture extends radially and circumferentially along the first wall.

4. The wheel of claim 1, wherein the aperture is tapered in a radial direction of the first wall.

5. The wheel of claim 1, wherein the first wall has an arcuate section, and the aperture is at least partially defined in the arcuate section.

6. The wheel of claim 1, wherein the rim portion has an inner surface and an outer surface, the inner surface being laterally sloped from a longitudinal center plane of the wheel towards the first wall.

7. The wheel of claim 1, wherein the aperture has a radially inner section and a radially outer section, the radially inner section having a first width and the radially outer section having a second width, the first width being different from the second width.

8. The wheel of claim 7, wherein the first width is larger than the second width.

9. The wheel of claim 1, wherein the aperture is a first aperture, and the second wall defines a second aperture providing a pathway to the interior chamber for the evacuation of the forming material, and shaped for evacuating debris introduced into the interior chamber in operation.

10. The wheel of claim 9, wherein the first aperture has a radially elongated shape and the second aperture has a circular shape.

11. The wheel of claim 1, wherein the first wall defines a plurality of apertures, including the aperture and an other aperture, the other aperture provides a pathway to the interior chamber for the evacuation of the forming material, and shaped for evacuating debris introduced into the interior chamber during movement of the wheel.

12. The wheel of claim 1, wherein:
the hub portion has an outer radial surface;
the rim portion has an inner radial surface;
the first wall has a first inner lateral surface;
the second wall has a second inner lateral surface; and
the interior chamber is defined by the outer radial surface of the hub portion, the inner radial surface of the rim portion, the first inner lateral surface of the first wall and the second inner lateral surface of the second wall.

13. The wheel of claim 1, wherein the integrally formed body is a cast body, and the forming material is a casting material.

14. A tandem wheel assembly comprising:
a connecting structure;
a first wheel according to claim 1, the hub portion of the first wheel defining a first hub aperture;
a first axle received in the first hub aperture, the first axle being connected to the connecting structure;
a second wheel according to claim 1, the hub portion of the second wheel defining a second hub aperture; and
a second axle received in the second hub aperture, the second axle being connected to the connecting structure.

15. The tandem wheel assembly of claim 14, wherein the second axle is spaced from the first axle in at least one of a longitudinal direction and a lateral direction.

16. A track system comprising:
a frame;
a sprocket wheel assembly rotationally connected to the frame;
an idler wheel assembly rotationally connected to the frame;
a plurality of support wheel assemblies rotationally connected to the frame,
at least one of the idler wheel assembly and the plurality of support wheel assemblies including a wheel, the wheel comprising: an integrally formed body including:
a hub portion;
a rim portion; and
a first wall and a second wall, the first and second walls connecting the rim and hub portions, and extending radially between the hub and rim portions;
the hub portion, the rim portion, the first wall and the second wall defining an interior chamber configured to hold forming material;
the first wall defining an aperture providing a pathway to the interior chamber for the evacuation of the forming material, and the aperture being shaped for evacuating debris introduced into the interior chamber in operation.

17. The track system of claim 16, wherein the aperture extends in at least one of a radial and circumferential direction along of the first wall.

18. The track system of claim 16, wherein the aperture is a first aperture, and the second wall defines a second aperture providing a pathway to the interior chamber for the evacuation of the forming material, and shaped for evacuating debris introduced into the interior chamber in operation.

19. The track system of claim 16, wherein the integrally formed body is a cast body, and the forming material is a casting material.

20. The track system of claim 16, wherein one of the plurality of support wheel assemblies includes the wheel, and is a tandem wheel assembly.
